(19) United States
(12) Patent Application Publication
(10) Pub. No.: US 2002/0002558 A1
(43) Pub. Date: Jan. 3, 2002

(54) Method and apparatus for providing customized date information

(76) Inventor: Thomas W. Krause, Falls Church, VA (US)

Correspondence Address: Thomas W. Krause, Esq., 210 E. Fairfax Street, No. 113, Fall Church, VA, 22046, US

(21) Appl. No.: 09/759,215

(22) Filed: Jan. 16, 2001

Related U.S. Application Data
(60) Provisional application No. 60/176,017, filed on Jan. 14, 2000.

(51) Int. Cl. G06F 17/30

(52) U.S. Cl. 707/104.1; 707/1

(57) ABSTRACT

The invention concerns uses of an “age-event database” that contains entries describing events that occurred in the lives of individuals at a certain age. Inputting a target individual's age (or a birthdate, from which the age can be calculated), yields output consisting of information from the age-event database. Thus, the database can be used to create greetings, greeting cards, calendars, and other date-related products that inform the user or recipient of accomplishments of famous individuals, or individuals known to the user or recipient, when they were the user or recipient's age.

This application is based on Provisional Application No. 60/176,017 filed Jan. 14, 2000, to which priority under 35 U.S.C. §119(e) is claimed. The specification of No. 60/176,017 is incorporated herein by reference.

### BACKGROUND OF THE INVENTION

This invention relates generally to the field of computer software for production of calendar and life history information. The invention comprises an interactive database that can be used to apprise the user of accomplishments or occurrences in the lives of other individuals—such as famous persons—that occurred when the other individual was a certain age, such as the age of the user or an acquaintance of the user. This information can then be used to create calendar entries, greeting cards (electronic or otherwise), birthday cards, other personalized forms of communication, or can serve as a theme for parties or other gatherings.

### DESCRIPTION OF THE RELEVANT ART

In the current art, calendars typically provide interesting or useful information of general applicability. Thus, a calendar might remind the user of specific dates that are recognized as National Holidays. Other calendars provide information about historical events that occurred on a certain day. More recently, Internet electronic calendars have been developed that automatically notify the user of upcoming events (book releases, theater events, etc.), of specific interest to the group of users who have chosen those events as areas of interest. While such an electronic calendar may be customized to suit an individual user's tastes, such calendars still provide the same date information to all users—the date of a particular event will be the same for all users.

The art also includes “personalized” calendars that are available by mail order, at photo processing centers, or through the Internet. By submitting a few photographs and a listing of important dates, a purchaser can obtain from a manufacturer (or an electronic calendar producer) a calendar that comprises pictures and date annotations of the user's choosing. Thus, for example, in the present art, a user may thereby create a personalized calendar that comprises family pictures, as well as reminders of birthdays of family and friends.

The present invention derives from the observation that people take a keen interest in how they are performing in life's journey as compared to other people, whether they be famous people, relatives, acquaintances, or competitors. Thus, the day that a man is as old as his father was on the day his father died is a significant day for many men, yet a man will often allow the anniversary to slip past unobserved because there is no mechanism in place for reminding him that he has reached that age. Some elderly persons keep track of the ages at which people known to them died, and view it as a minor triumph to have outlived someone in this manner. Members of professions also routinely compare their “progress” against that of competitors or icons in the field in terms of their age. Thus, some baseball players are interested in being reminded whether or not they have hit more home runs, or stolen more bases, than other—perhaps more famous—baseball players at their age. If the user comes out ahead, then perhaps the disparity will be a source of satisfaction. If the user comes up short, then—at least for some persons—the disparity will be a source of motivation. If the user comes up very short, then perhaps this will promote a sense of wonder, or a sense of desperation, or might suggest to the user that it is time to change professions.

The present invention encompasses various uses of an age-event database. The age-event database contains information about events in the lives of individuals (potentially including famous individuals, fictional characters, and/or individuals known to a user), where each event can be correlated to the age of the individual or individuals involved in the event. One use of the age-event database is for generation of a calendar that as ancillary information provides information about events of particular interest to the user because they occurred in the life of an individual at a time when that individual was exactly the same age of the user. Another use of the age-event database is as part of a system for producing personalized greetings—including greeting cards—based on the information in the database, as compared to the age of the recipient and/or the sender of the greeting card. In contrast to prior art greeting cards—which often express deep and personal sentiments without meaningful input from the sender—greeting cards made pursuant to the present invention provide the sender a unique opportunity to provide personalized commentary to the recipient. Yet another use of the age-event database is as part of a system and method for producing a “life reading,” which as an output can take any number of forms, from a calendar, to a printout, to a book, in which—using as input the birthdate of an individual—the life of that individual is “charted” in terms of what other people did when they were that person's age. Thus, the user could view listings of things that famous people accomplished when they were younger than the user (perhaps giving a sense of hopelessness of accomplishing anything truly meaningful in life), or listings of things that famous people accomplished when they were older than the user (perhaps giving a sense of hope of yet achieving something meaningful in life). Yet another use is as a life-comparator, where the user is enabled to plot dates in her life against important events that occurred in the life of another person. Yet another use for the database is found in the context of a “life-clock,” which comprises a graphical representation of an individual's life span, including time lived, time remaining to live, and an indication of how far between birth and death the individual has progressed. In such a life-clock, graphical representations of events from the age-event database can be included.

This invention is in part enabled by the current art, which comprises the ability to create databases and to retrieve information from those databases in response to input from a user. This invention is further enabled by the current art of computer programming and hardware design, which permits a computer programmer and engineer of ordinary skill to perform the programming steps necessary to implement this invention with reference to this description and the accompanying drawings.

### OBJECTS AND SUMMARY OF THE INVENTION

The present invention provides various methods for providing personalized information on calendars, greeting cards, and other items based on the user's birthdate.

One object of the present invention is to provide a user with benchmarks of accomplishments of others to use as goals in her own life.

Another object of the present invention is to enable a user to compare her past and future with the life of another individual.

Another object of the present invention is to provide entertainment by providing access to significant and/or interesting information that would otherwise be difficult to access.

Another object of the present invention is to enable a user to generate a “life calendar” that charts out one's own future as well as past in terms of the lives of others.

Another object of the present invention is to provide a novel means for encouraging individuals to send greeting cards and other communications to other individuals.

Another object of the present invention is to provide a novel means for encouraging individuals to send uniquely personalized greeting cards to other individuals.

Another object of the present invention is to provide a means for generating advertising revenue based on providing targeted advertising based on user interests as evidenced by the user's use of the database.

Another object of the present invention is to provide a means of providing targeted advertising without compromising the privacy of the user.

Another object of the present invention is to provide a “life-clock” that provides a graphical representation of the time that an individual user has left to him, the time that such a user has already “used up”, along with information about other individuals (usually, famous or known to the user), arranged chronologically in comparison to the user's life.

Another object of the invention is to provide a means for attracting Internet users to a web-site.

Another object of the invention is to provide a means for advertising and selling merchandise related to age-event information provided to a user.

Additional objects and advantages of the invention are set forth in part in the description that follows, and in part are obvious from the description, or may be learned by practice of the invention. The objects and advantages of the invention may also be realized and attained by means of the steps, instrumentalities and combinations particularly pointed out in the appended claims.

A preferred embodiment of the method of the present invention, as broadly described herein, comprises the steps of obtaining age information for a target individual, retrieving from an age-event database information based on the age information so obtained, and outputting the age-event information. The outputted information can be used to customize and personalize calendars, greeting cards, emails, letters, advertisements, life charts, life-clocks, and other means of keeping time (including as a display on a wristwatch).

Also, according to the present invention, a device comprising means for effectuating the method of the present invention is provided. Further according to the present invention, computer-readable memory encoded with a program directing the computer system to effectuate the method of the present invention is also provided.

### BRIEF DESCRIPTION OF THE DRAWINGS

The accompanying drawings, which are incorporated in and constitute a part of this specification, illustrate particular embodiments of the invention, and together with the description, serve to explain the principles of the invention.

FIG. 1 is a block diagram of a computer system as may be utilized by the present invention.

FIG. 2 presents a block diagram of a database information flow system as may be utilized by the present invention.

FIG. 3 depicts a computer screen that is first seen by the user upon accessing a web-site embodiment of the invention.

FIG. 4 depicts a computer screen from a web-site embodiment of the invention showing ageliners for a celebrity.

FIG. 5 depicts a computer screen from a web-site embodiment of the invention showing ageliners for a target individual.

FIG. 6 depicts a computer screen from a web-site embodiment of the invention showing a means for emailing an ageliner using the web-site.

FIG. 7 depicts a computer screen from a web-site embodiment of the invention showing a timeline of the life of an age-event individual

FIG. 8 is a representation of a portion of the age-event database, as used in a preferred embodiment of the invention.

FIG. 9 presents a block diagram depicting one method of creating an age-event database.

FIG. 10 presents a block diagram for creating a calendar using the invention, including an optional filtering step.

FIG. 11 presents a sample input screen for generating a calendar of the present invention.

FIG. 12 depicts a portion of a calendar generated according to the present invention.

FIG. 13 is a block diagram for creating a greeting card using the present invention.

FIG. 14 depicts a greeting card as may be generated by the present invention.

FIG. 15 depicts a life-clock of a preferred embodiment of the present invention.

### DEFINITIONS

“Age-event,” or “age-event information,” as used herein, refers to information in the age-event database. This information typically comprises a record of a database, which contains the name of an individual, an event that occurred in the life of that individual, and the age (or information sufficient to calculate the age) of that individual at the time of that event. In some embodiments, two connected databases—one containing name and event information, and one containing name and age information—are used.

“Age-event database” refers to a database, or a set of two or more related databases, containing age-event information. While this specification typically refers to “age-event database” in the singular form, it should be understood that this term encompasses the use of more than one database. For example, one preferred embodiment of the invention uses two related databases, one to store information about events, and another to store age information concerning individuals involved in those events.

“Age-event individual,” as used herein refers to an individual whose name is associated with an event in the age-event database.

“Age information,” as used herein, is information relating to a person's age, and normally comprises information sufficient to determine a person's age on a specified date or over a specified set of dates. Examples of “age information” include an expression of the age of an individual (for example, 35 years, 4 months and 2 days, or the same age as expressed in years in decimal form (i.e. 35.34 years), weeks, days, hours, minutes or seconds or any other unit of or information sufficient to calculate the age of an individual (for example, the birthdate of an individual, in conjunction with the current date; or the date on which an individual celebrated a particular birthday, combined with the date at which the person's age is to be determined). While many embodiments of the invention involve the use of an age calculated to the exact day, such precision is not always necessary for the practice of this invention; for example, some embodiments use ages calculated to the nearest year, and for other embodiments, the “age” that is commonly referred to as a person's age (i.e. an expression of the number of complete years a person has lived) is used.

“Ageliner™”, as used herein, refers to a statement comparing a first person's age on a given date to the age of an age-event individual when a notable event in the age-event individual's life occurred. An ageliner directed at a user who was 14462 days old today might read: “Today, you are exactly as old as Benedict Arnold was when he secretly promised to surrender the West Point fort to the British army (14462 days old, or about 39.6 years old).”

“Calendar,” as used herein, is any means for displaying or recording date information, including all meanings of “calendar” embraced by standard dictionary definitions of the term, as well as electronic calendars for use with personal computers, palm pilots, and the like.

“Target” or “target individual,” as used herein, refers to the individual whose age forms the basis of the age-event product produced in accordance with the invention. Examples of targets are the recipient of a greeting card produced pursuant to the invention, or the individual for whom a customized calendar, life-clock, or life-reading is created according to the invention. The user who inputs his own age information just to check the output is also considered a target.

“Life-clock,” as used herein, is any depiction of a living individual's life-span that includes an indication of how long that individual has already lived.

### DETAILED DESCRIPTION OF THE PREFERRED EMBODIMENTS

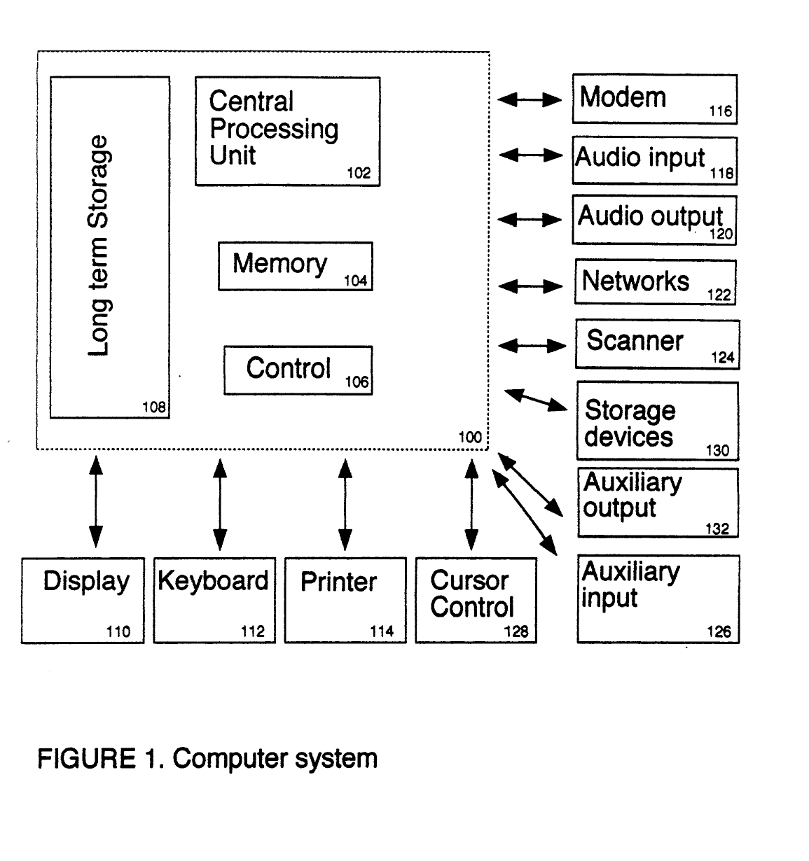

The invention is described in the context of a computer system (100), as pictured in FIG. 1, which consists of at least one Central Processing Unit (102), short term memory (104), a Control function (106), and random access long-term storage such as a hard disk or other disk drives (108). In addition, such systems may contain additional means for input such as storage devices (130), a keyboard (112), one or more cursor control devices (128), auxiliary input (126), scanners (124), audio input such as a microphone (118), for output such as storage devices (130), amplified loudspeakers for audio output (120), one or more display devices such as a monitors (110), one or more printers (114), auxiliary output (132), and access to other computer systems via modem (116) or networks (122). Thus, a computer system includes devices currently known as personal computers, mainframe computers, supercomputers, laptop computers, personal digital assistants, network computers, servers, routers, hubs, control boxes, etc. A computer system is also defined as a network of computer systems, including local area networks, dial-up networks, wide area networks, and the Internet. The preferred embodiment is described in the context of a computer system which is capable of running programs in a Windows® environment. One example of a stand-alone version of the system is an automated greeting card creation kiosk, where the kiosk provides age-event information in response to user input, and enables a user to generate a greeting card containing age-event information at the location of the kiosk.

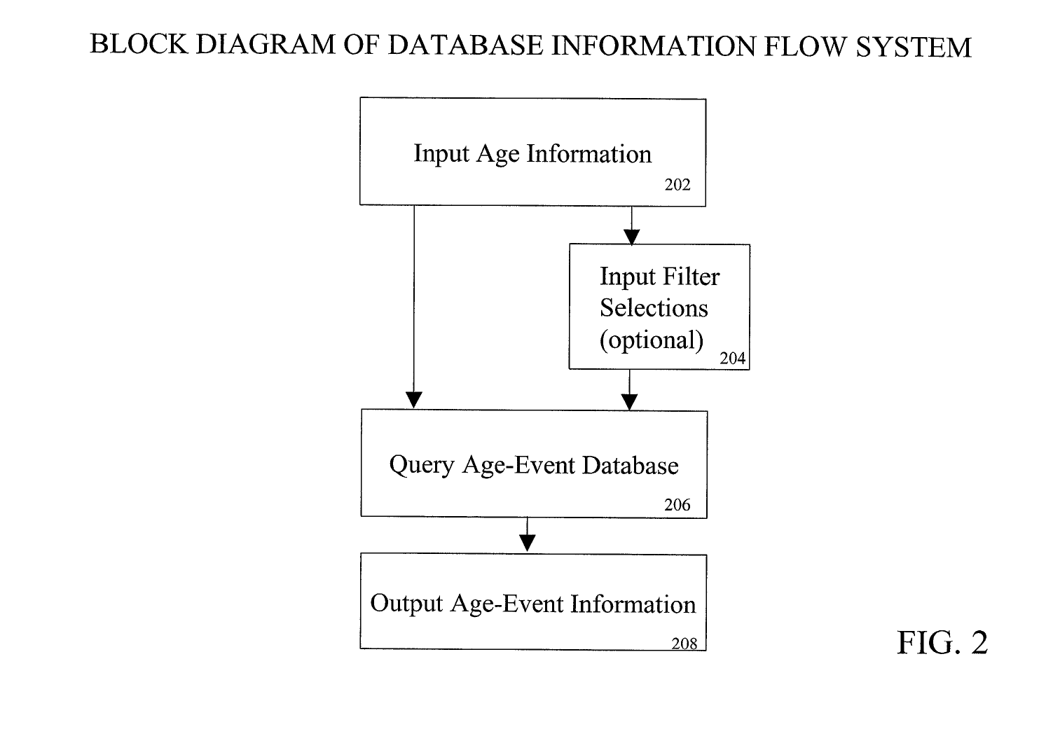

FIG. 2 is a flow diagram depicting the overall operation of the invention. While the invention can be practiced in a manner different from that depicted in the flow diagram, the flow diagram provides a useful overview for understanding the invention.

The invention involves, among other things, the use of a computer system, such as depicted in FIG. 1, to provide a user with information related to the age of a person of interest (a “target” person) on a particular date or through a particular date range, or even for an undefined period in the future or the past. In a preferred embodiment, as shown in FIG. 2, the invention comprises the step of receiving age information input from which the computer system can determine the age of the target individual on a specified date or date range (202). Typically this step involves inputting the birth date of the target individual, and, using the computer system, calculating the age of the target individual date on the current date, a specified date, or a specified range of dates. In some embodiments—especially where the exact age of the target individual is not important—the input could simply be the age, in complete years, of the target individual. In one preferred embodiment of the invention, the user can create a birthday card for a target individual that lists accomplishments of others when they were the age that the target turned on his birthday.

For a calendar embodiment of this invention, the date range for which ages are calculated would typically be for the current or upcoming calendar year. For a greeting card embodiment, the date range could simply be the current date, or all the dates in the upcoming month, or could be determined by the number of age-events that fit on a single computer screen. For a greeting card that is tied to a particular date (such as Father's day), the date range could simply be that date. For other embodiments, such as the life-clock or life chart, the date range could comprise most or all of the (expected) lifetime of the target individual. In other embodiments of the invention, the user can simply pick an age—perhaps the age he will be in 5 years, or the age he was 5 years ago—and receive as output age-event information relevant to the selected age.

In some embodiments, the user has the option to input filter selections (204). This involves selecting parameter values that will limit the outputted age-event information according to the user's preferences, or the preferences that the user believes a target individual to have. Thus, as discussed further below, by selecting certain parameter values, a user can create a filter that “filters” the output from the age-event database to include only age-event information relating to females, or to politicians, or to religious figures, or to the deaths of age-event individuals. Similarly, a filter can be used to filter out certain categories of information, such as deaths. In an Internet embodiment of the invention, the user's filter choices can be used advantageously for purposes of targeted advertising. Thus, a user that selects a “science” filter might be targeted with advertisements directed to someone with an interest in science.

Query age-event database step 206 involves the computer system searching for and retrieving age-event information from the age-event database that corresponds to the age-information input in step 204. In a preferred embodiment, the computer system retrieves database entries involving age-event individuals who, at the time of the age-event, were the same age as the target individual was or would be on a particular date within the applicable date range.

The output generating step (208) provides an output corresponding to the inputted age-information. The output thus generated comprises information about other individuals—usually famous individuals or individuals known to the target individual—and events that occurred in those other individuals' lives when they were the same age as the target individual, or when they were an age that bears a specified relationship to the age of the target individual.

In some embodiments, the user need not specify a particular relationship between the age of the target individual and the age of the age-event database individual, but will receive as output information about mathematical relationships between the age of the target individual and an individual in the age-event database. For example, the output might state the fact that Mozart composed his first symphony when he was one-fifth the target individual's age (or the square root of the individual's age); or that Penelope Fitzgerald wrote her first novel when she was three times as old as the target individual.

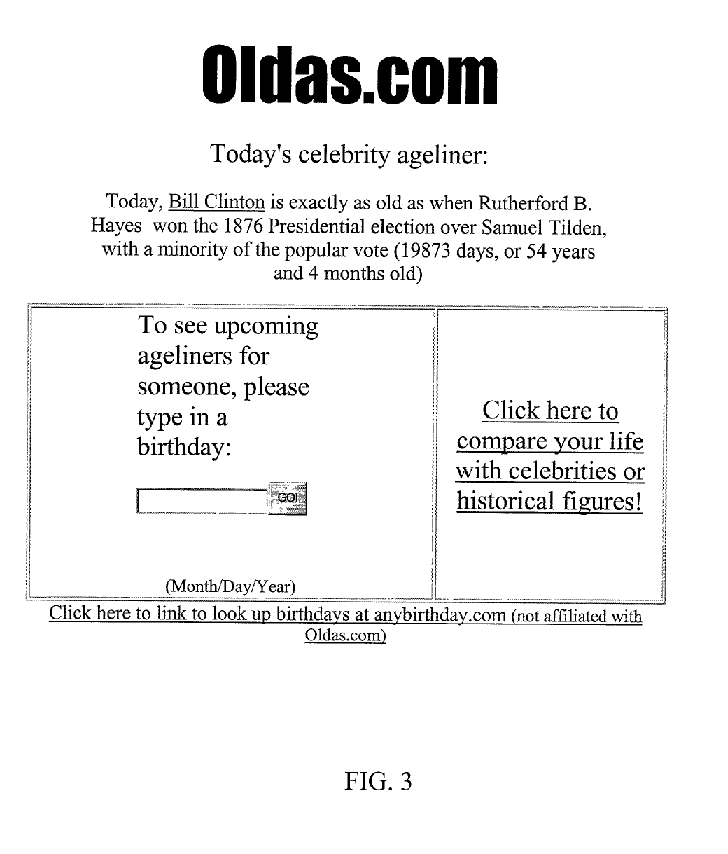

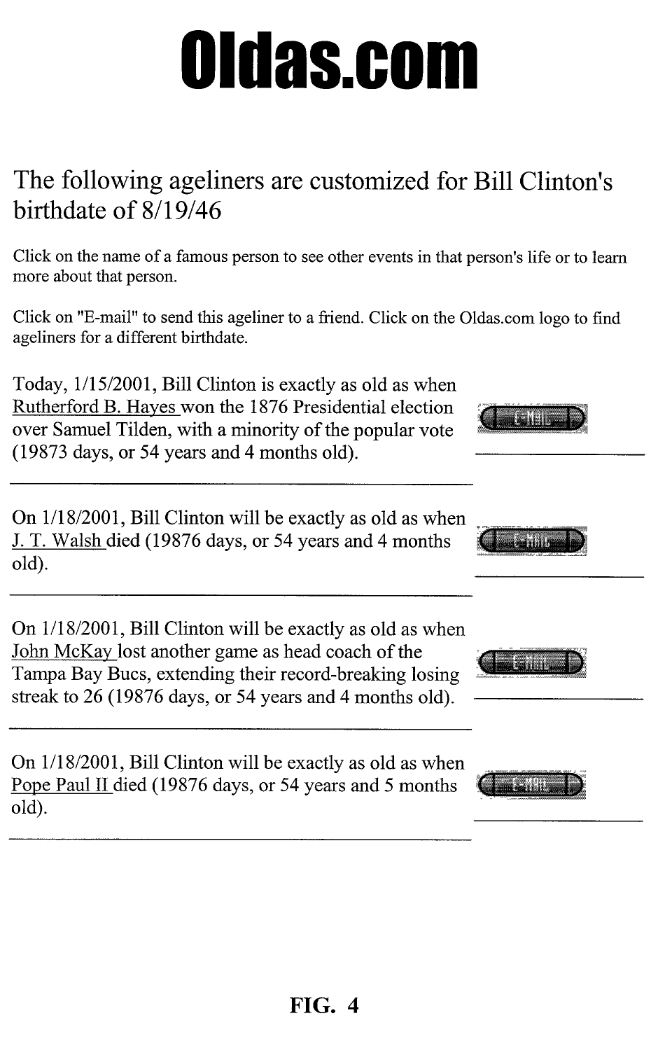

FIGS. 3-7 depict typical screens that are encountered on a web-site embodiment of the present invention. As shown in FIG. 3, the user is greeted with a screen that presents a “celebrity ageliner.” In this case, the celebrity ageliner states that “Today, Bill Clinton is exactly as old as when Rutherford B. Hayes won the 1876 Presidential election over Samuel Tilden, with a minority of the popular vote (19873 days, or 54 years and 4 months old).” The celebrity ageliner thus provide the user a quick—and potentially interesting—demonstration of the functionality and purpose of the web-site, without any user input. The celebrity ageliner is generated from two lists; the first list being a list of well-known, living celebrities, and the second list being the age-event individuals (or a filtered portion of the age-event individuals) in the age-event database. In a preferred embodiment, the celebrity ageliner for a given day changes every time a user visits the site on that day. In another preferred embodiment, celebrity ageliners are selected in advance by the web-site managers from the list of all possible celebrity ageliners for an upcoming day. Clicking on the name of the celebrity in the celebrity ageliner calls up a screen that presents upcoming ageliners for that celebrity (FIG. 4).

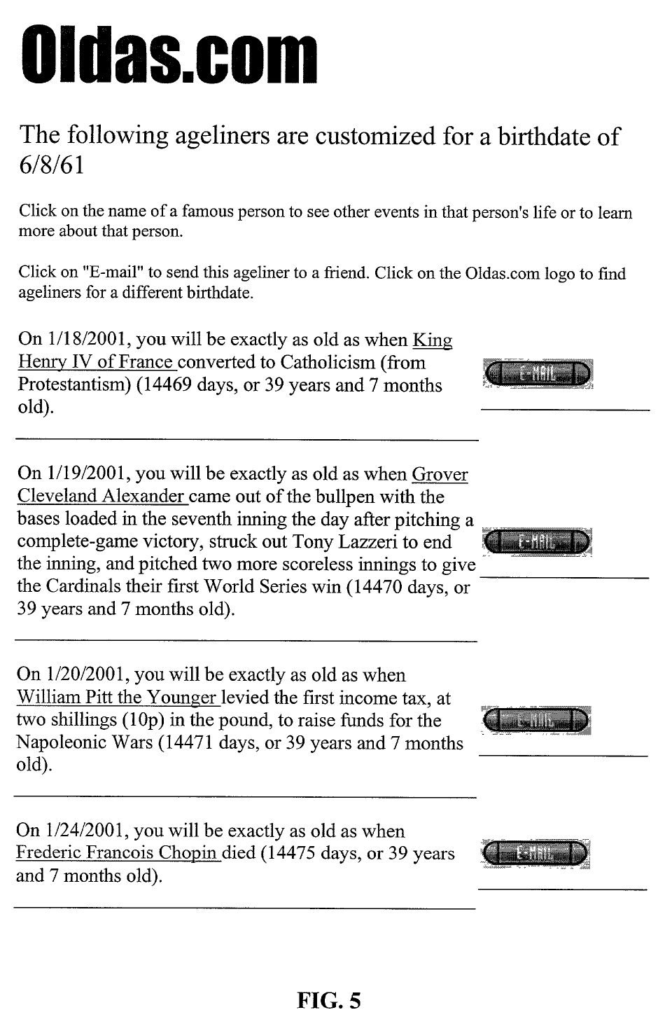

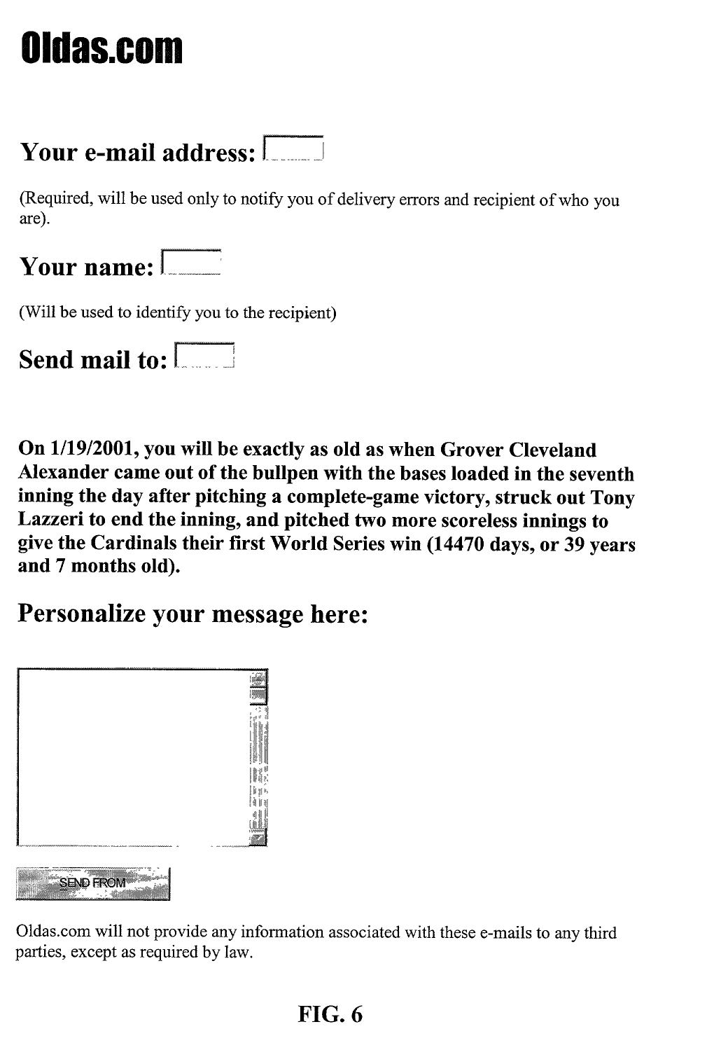

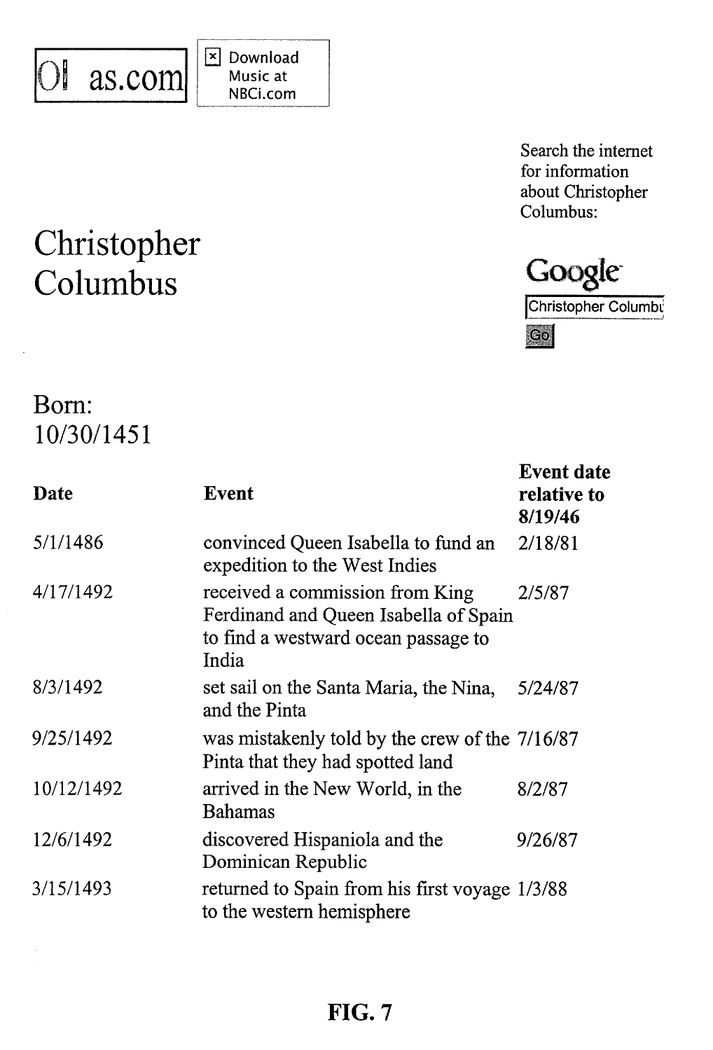

Returning to FIG. 3, the user is prompted to enter a birthdate. FIG. 5 is a screen that would be encountered by an individual who entered the birthdate Jun. 8, 1961 sometime before Jan. 18, 2001. As depicted in FIG. 5, the user is presented with a list of upcoming ageliners for an individual with the birthdate Jun. 8, 1961. Clicking on any of the “Email” buttons in FIG. 5 calls up a screen as depicted in FIG. 6, which provides the user the ability to email the selected ageliner to a friend, presumably having the birthdate Jun. 8, 1961. From FIG. 4 or FIG. 5, clicking on the underlined name of an age-event individual calls up a screen (FIG. 7) that provides a timeline of the life of that age-event individual, comprising a list of all entries in the age-event database related to that age-event individual. In the preferred embodiment depicted in FIG. 7, the same page also provides the user with a “life comparator” relating events in the age-event individual's life to the corresponding dates in the target's life. In other words, the user is able to see at what date in a target's life the target was as old as the age-event individual, for any event in that age-event individual's life. Also provided in FIG. 7 is a link to a commercial search engine, which provides automatic access to a commercial search engine with the name of the age-event individual as the query. Typically, this will provide the user with additional interesting information about the age-event individual, or will assist the user in identifying the age-event individual. As an additional advantage of the invention, links such as these typically provide affiliate revenue to the web-site.

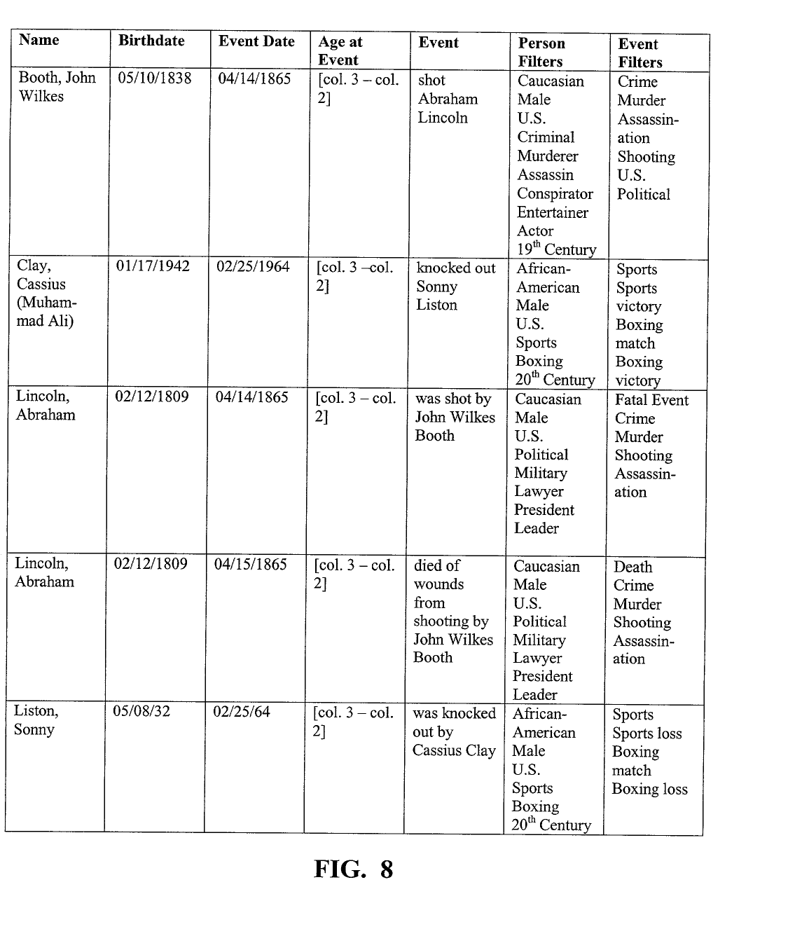

As already mentioned, an important component of this invention is a database of names, events, and dates—the “age-event” database. FIG. 8 is one particular graphical representation of several entries from such an “age-event” database. As shown in FIG. 8, the age-event database can comprise entries that comprise the name of a person (usually a famous person, often a person known to the user), a description of an event that occurred in the life of that person, and information sufficient to determine the age of that person at the time of the event. As depicted in FIG. 8, a line of the data relating to the age-event corresponding to Cassius Clay (Muhammad Ali) having knocked out Sonny Liston consists of Cassius Clay's name and date of birth, the date on which the fight occurred, a description of the event, and a calculated value corresponding to Cassius Clay's age at the time of the event. In another embodiments, the data can be stored in more than one database.

In a preferred embodiment (not depicted in FIG. 8), the database can also include commentary related to the event in question, directed to an individual the same age as the age-event individual in the age-event database. For example, the comment for the Clay-Liston fight directed to a target the same age as Cassius Clay might be “Shouldn't you be working out more often?” On the other hand, the comment directed at a target of Sonny Liston's age might be “No matter what, you probably had a better day than Sonny did at your age.” These comments then could then appear (or be made to appear at the user's option) on a calendar, greeting card, e-mail, or life-clock of the present invention. In a preferred embodiment, the user can substitute his or her own personalized commentary, which relates the age-event more personally to the life of the target. For a life-chart embodiment of the invention—or any embodiment where past events in the target's life are recorded or addressed—a comparison could be made between what the target individual did on a particular day and what the age-event individual did.

The database can include the birthdate of the person and the date on which the event occurred, in which case the person's age at the time of the event could be a calculated value determined by subtracting the birthdate from the event date. Alternatively, the person's age at the time of the event could be predetermined, in which case the database would not be required to contain birthdate or event date information. In other words, in addition to a database that contains birthdate and event date information, the invention also embraces a database that does not contain birthdate and event date information, but rather contains the exact age of the person involved in the age-event at the time of the age-event. Such a database could easily be created from the database that contains birthdate and event date information, and, in some embodiments, it may be advantageous to do so. Any “age-event” database, or combination of databases, that provides the ability to correlate the age of an individual to an event in that individual's life at that age is within the scope of this invention.

The age-event database can be created using a customized database creation program, such as FileMaker Pro®, in a manner that will be readily apparent to one with skill in the art of computer programming and/or database management. Input can be accomplished using biographical works or other historical works that emphasize dates, as well as lists of birthdays of famous people. Where the input information exists in or can be converted to electronic form, creation of the age-event database can be significantly automated.

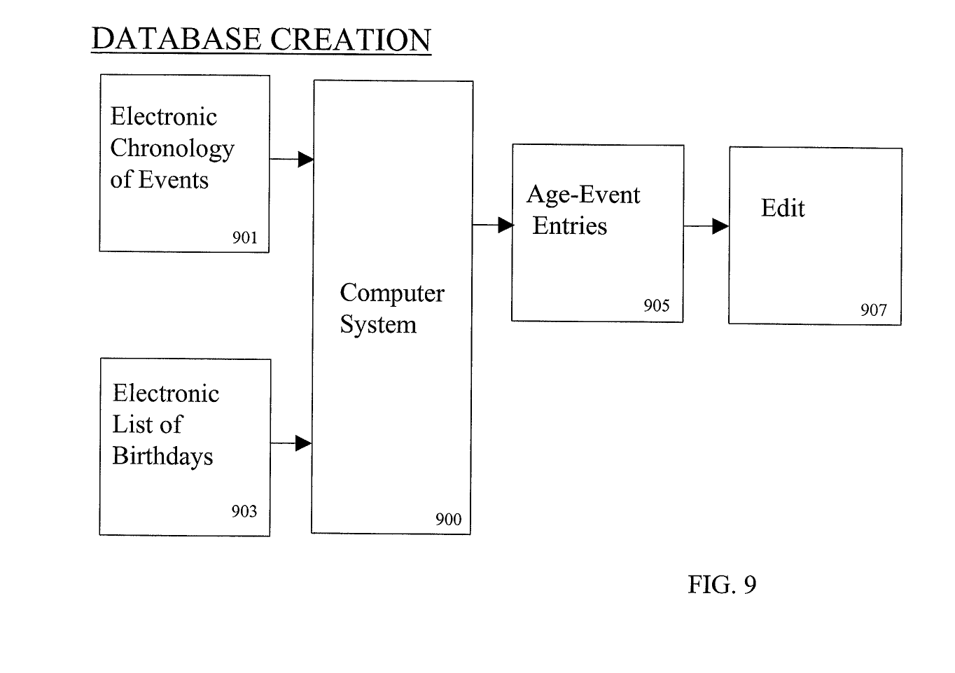

As depicted in FIG. 9, the invention also comprises a computer system (900) that takes as an input an electronic chronology of events (901), along with an electronic list of birthdays (903), and creates age-event database entries (905) according to the present invention. In a preferred embodiment, the user creating the database entries can review and edit (907) the entries to address any ambiguities or errors that may have been introduced as a result of (for example) incomplete information contained in either the electronic chronology (901) or the electronic birthday list (903). Thus, for example, the electronic chronology might identify a particular individual by last name only, whereas the birthday list might include entries for more than one individual with that last name. In such cases, user input may be required to ensure that the use of the data from both lists is optimized. In a preferred embodiment, edit step 407 also comprises entering person parameters and event parameters, discussed in more detail below, for each age-event individual. The programming steps necessary to create a computer program for creating age-event database entries in this manner will be readily apparent to one with skill in the programming art.

The database need not exclude interesting age-event information simply because precise dates and birthdates are not known, as will often be the case for age-event individuals who lived in the distant past, or for whom accurate birth records are unavailable (as, for example, not only for individuals who lived long ago, but also for present-day adopted individuals whose precise birth dates are not known). In such cases, in a preferred embodiment, the creator of the database will typically include “best-guess” information in the database, and create the database entry such that when the entry forms the basis of an output to a user, the user is informed that the date and age information is not certain. For embodiments of this invention that are only concerned with ages in terms of years, or complete years (rather than to the day), such approximations will normally provide accurate results.

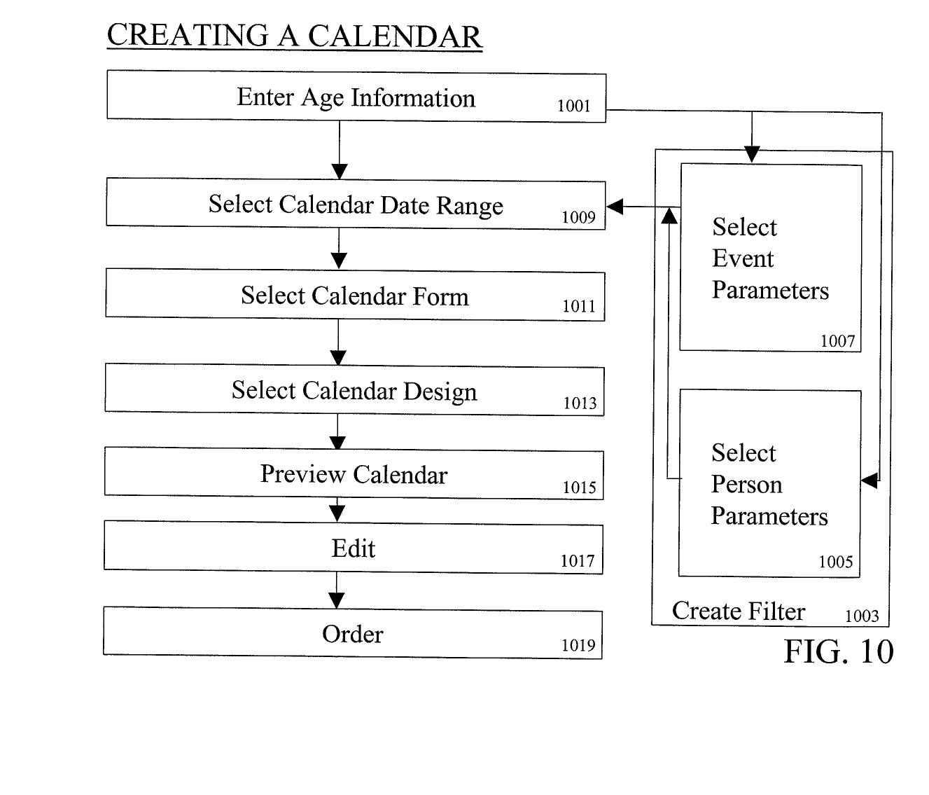

FIG. 10 is a block diagram for a preferred embodiment of a process for creating a customized calendar using the present invention. In the preferred embodiment of FIG. 10, in addition to obtaining birthdate or age information from the user (1001), the computer system allows the user to create a filter (1003) by collecting information that will be used to filter the data that is output to the user on the calendar. Thus, the user may “filter” calendar entries by (1) selecting any or all personal characteristics—the person parameters—to describe the age-event individuals he or she is interested in tracking (1005), and/or (2) selecting from various types of occurrences—event parameters—to describe the kinds of events he or she is interested in tracking (1007).

The parameter selecting steps 1005 and 1007 provide the ability to determine the sort of output desired. In a preferred embodiment, there are two types of parameters—person parameters and event parameters. Person parameters are parameters that describe an individual, including information that can describe the individual's profession, nationality, race, or era—for example, military, political, American, Caucasian, female, children, sports, science, astronaut, film, 19^{th} century, celebrity, rich, inventor, religious, etc. In a preferred embodiment, each age-event individual has a plurality of person parameters assigned to him. For a given age-event database, the list of person parameters can be created efficiently by simply entering all conceivable person parameters relating to each age-event individual as an entry concerning that individual is reviewed. As more age-event individual entries are reviewed, eventually there will come a point when there are no new person parameters to enter.

Event parameters are parameters that describe an event, and the parameters in some cases overlap—in name at least—with the people parameters. Thus, event parameters will also include parameters like military, political, American, sports, science, space, film, 19^{th} century, invention, religion, etc. However, the event parameters include parameters such as “family” and “death”, and it is common for a person who is classified by one or more person-parameters to be involved in an event that is classified in terms of an event parameter that differs from the person parameters. Thus, a politician might accomplish something in a sporting event, or play a role in a scientific discovery, even though her person-parameters did not include sports or science. In a preferred embodiment, each event in the age-event database has at least one event parameter associated with it.

In other preferred embodiments, more categories of parameters can be used. Thus, for example, the person parameters described above may be expressed as two or more kinds of parameters, such as “professional” and “individual”, where “professional” relates to the profession of an individual (or the individual's field of accomplishment), and “individual” relates to characteristics such as race, nationality, sex, wealth, or weight-class.

In a preferred embodiment, by designating a specific value or values for the person parameters and event parameters, the user is able to “filter” the age-event database to provide only information falling into the specified categories. It is anticipated that some individuals will only be interested in information relating to the age at death of famous individuals, without any particular concern for the person parameters discussed above. Other individuals may wish to filter out death information entirely. Yet other individuals might be interested only in the lives of a select group of individuals. Thus, in another preferred embodiment, the user has the ability to simply select the “names” from the name event database that she wants to have appear in the output. Of course, the user may elect to forgo any filter, and then edit the output to include only the age-event or age-events that the user considers appropriate for the target.

One drawback of the invention for older people who are more interested in life-events than deaths is that as the age of the target increases, the number of events that are deaths also increases. Thus, in another preferred embodiment, the program can automatically filter an increasing percentage of the deaths as the the age of the target individual increases. Thus, for example, regardless of the age of the target, the program can ensure that no more than 20% of the events reported are deaths.

In another preferred embodiment, the user can construct his own search for responsive age-event entries. Thus, while the program might not itself contain a parameter for first names, the user could conduct a search for all age-event entries where the age-event individual had a first name of Tom or Thomas. In such an embodiment, the search prompts the user to specify fields to search, where the fields include “first name,” “last name,” “event,” and “commentary.” Search engines for accomplishing such searches are well known in the art and are readily programmed in a FileMaker Pro® environment.

In another preferred embodiment, the user simply is provided all age events for the period of time covered by the calendar, and is given the option of deleting those age events that she does not want included in the calendar.

After selecting the calendar date range (1009) (usually one calendar year), the user of a preferred embodiment is prompted to choose the form of the calendar (1011). Possible forms include page-a-day, weekly-planner, or wall calendars, as well as various types of electronic calendars or notification systems. Following selection of the form the calendar, the user has the ability to select the design of the calendar (1013) from various designs contained in the computer system. In a preferred embodiment, the user has the ability to preview (1015) and edit (1017) the calendar prior to ordering (1019).

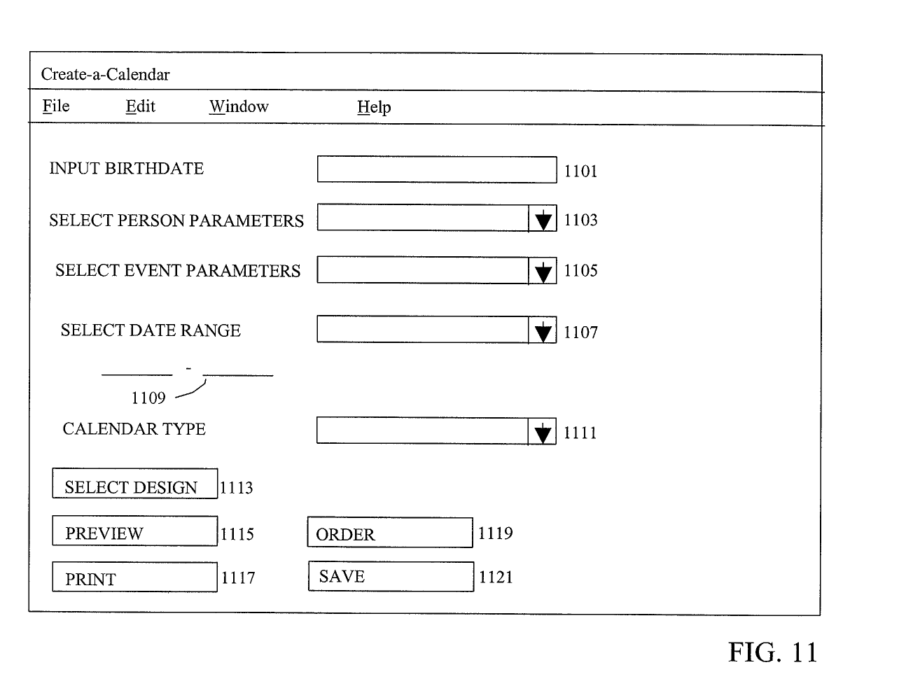

FIG. 11 is a display screen of a preferred embodiment for creating a customized calendar in accordance with the invention. First, the user inputs the target's birthdate in space 1101. The user is prompted to select one or more person parameters from a pull-down menu that appears when arrow 1103 is clicked, and is prompted to select one or more event parameters from a pull-down menu that appears when arrow 1105 is clicked. In a preferred embodiment, the user has the option of selecting “all” for either or both parameter selections, thereby not filtering the output in any way.

In a preferred embodiment, the default date range is the upcoming calendar year. The user can also type a preferred date range directly into space 1109, or can click arrow 1107 for a menu of alternative date ranges, including upcoming and past calendar years.

After selecting the filters and date range, in the preferred embodiment depicted in FIG. 11, the user can select the Calendar type (1111). The ability to print various types of calendars (including bound calendars, desk calendars, page a day calendars, and wall calendars) will depend on the user's printing equipment, and calendar-creation equipment.

In the depicted embodiment, clicking “select design” button 1113 calls up a different screen that provides the user a plurality of design options from which to choose. The selection may comprise all of the calendar designs stored in the computer system, or may give the user the option of selecting different components of the design. In a preferred embodiment, the computer can suggest a design based on the user's person parameter and event parameter choices, or based on age-event entries that appear on the calendar.

In a preferred embodiment, the calendar can also include commentary from the age-event database, or input by the user, as discussed in more detail below in the discussion of a greeting card embodiment of the invention. For electronic calendars, as for electronic greeting cards, the age-event entries corresponding to particular dates can also include sounds (such as recordings), graphics, and/or video (animated or live action) related to the age-event entry.

After selecting the design, the user is returned to the screen depicted in FIG. 11, and can click “Preview” 1115 to review the calendar prior to printing or ordering. In a preferred embodiment, the user also has the option of the editing the calendar at the “preview” stage, in order to eliminate unwanted entries, to provide her own entries, or to modify existing entries. “Print” 117 gives the user the option of printing out the calendar on her own printing equipment.

Clicking “order” 1119 calls up a screen for ordering the calendar that has been created by the user. The user can obtain an electronic version of the calendar to be stored (for example) on the individual's personal computer or web-site, or can elect to receive a hard copy of the calendar in the mail. Often, a user will generate a customized calendar as a gift for a friend. In an Internet embodiment, the user can order the calendar to be sent to a friend, either through the regular mail as a generated calendar, or via e-mail (or any other means of transmitting digitized information) as an electronic calendar. The principles governing creating and ordering an electronic calendar over the Internet are well-known to those with skill in the art in electronic commerce applications.

Finally, clicking “save” 1121 permits the user to save the customization of the calendar that she has effected in the previous steps, for possible later use.

In an Internet embodiment, the user can select to receive e-mail reminders of the events on his or her calendar; in fact, the user need not generate a calendar (and need only enter his birthdate) to receive an e-mail “reminder” service. Such a service automatically provides the user age-event information relevant to his age on the current date. As a source of revenue, this e-mail service can contain advertising. Thus, each entry in the age-event database could be “sold” or licensed for a period of time to an advertiser. An advertiser having bought an age-event entry could provide additional text linking its product or service to the particular piece of age-event information. Similarly, the web-site managers could target ads to users based on information such age, filters selected, or age-event information. In addition, affiliate agreements could provide additional revenue when senders or recipients of age-event information visit the advertiser's web-site through an Internet age-event information site, or in response to an age-event email containing advertising.

The invention can also be sold as part of a calendar creation kit, such as are currently commercially available, which can include software, hardware and/or instructions that permit a user to create his own personal calendar.

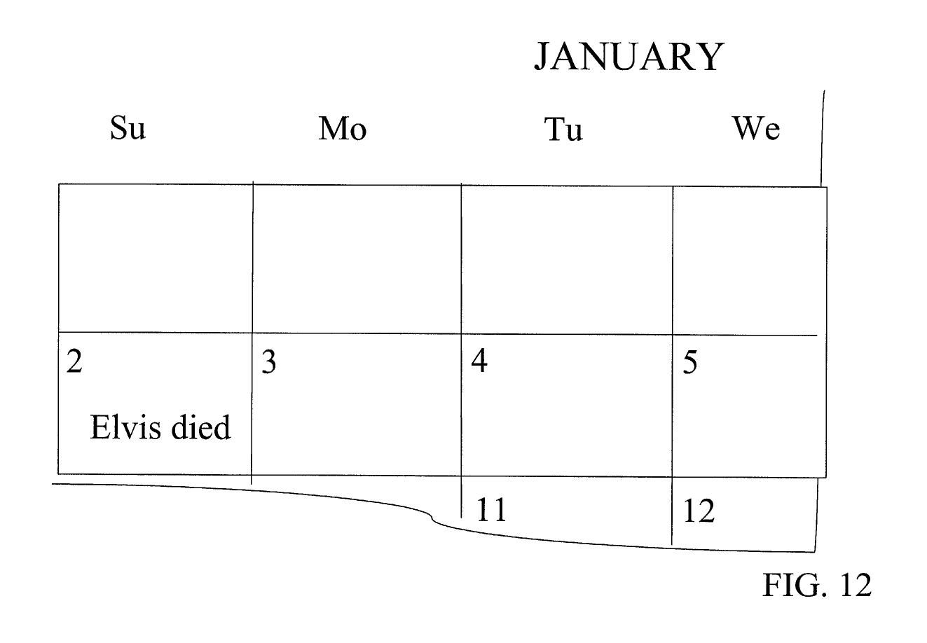

FIG. 12 depicts a portion of a calendar created according to the present invention. The depicted portion covers the period January 2 through January 5, and it can be seen that on Sunday, January 2, the individual for whom the calendar was customized was exactly the same age as Elvis Presley when Elvis Presley died.

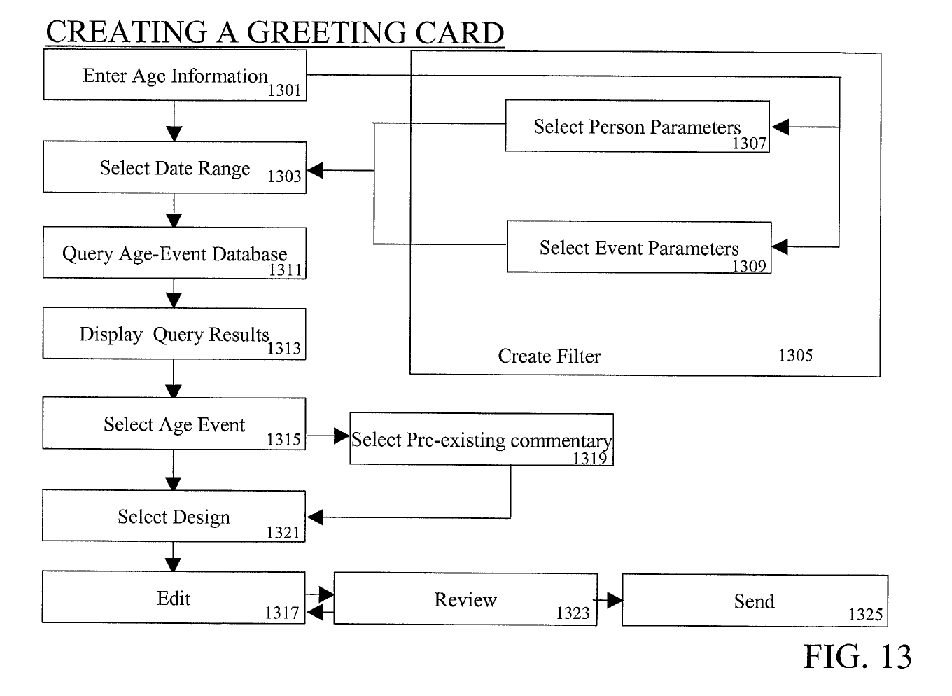

FIG. 13 is a flow diagram of the process for creating a greeting card according to the present invention. The greeting card can be created at a personal computer using software according to the present invention and an attached printer, at a automated personalized greeting card creation kiosk such as can be found at certain retailers (but which need not necessarily be located at a retail location), or over the Internet, for an electronic greeting card. In an Internet embodiment, the web-site can alternatively provide a hard copy of a greeting card to the target individual.

In the preferred embodiment depicted in FIG. 13, the user inputs the target individual's age information (1301), often consisting of the target's birthdate, and selects a date range (1303) for the greeting card. As shown in FIG. 13, the user may optionally be given the opportunity to create a filter (1305). The filter can be created based on selected values for person parameters (1307) and event parameters (1309) as already discussed in connection with a calendar embodiment of this invention. In cases where the age-event database is not voluminous, a user might prefer not to use any filter, on the theory that, given the narrow date range that a greeting card entails, there may only be a small number of responsive entries from the entire database. This small number could be easily reviewed by the user; thus, the filtering step is not always necessary. Even if the age-event information thus retrieved does not fall under the person or event parameters that might best suit the target individual, the user could draft appropriate commentary to match such an age-event to the target individual.

The inputted information from steps 1301, 1303, and 1305 (as well as from steps 1307 and 1309, if filters are used) is then used to query the age-event database (1311). The query results are then displayed (1313), in the form of age-event information corresponding to the age of the target individual in the selected date range, and filtered in accordance with any selected filter. In a preferred embodiment, the age-event information comprises information related to events that occurred in the lives of age-event individuals when they were the age or ages determined for the target individual. In another preferred embodiment, the relationship between the age of the age-event individual and the target individual need not be identity; rather, the output can comprise information about what an age-event individual accomplished when she was an age that bears a mathematical relationship to the age of the target individual (as for example, when the age-event individual's age is a multiple or a fraction of the age of the target individual, or where there is an exponential relationship between the ages).

The user reviews the age-event information displayed by the computer (1313), and selects one or more age event entries (1315) for use in creating the greeting card. In a preferred embodiment, the user can select commentary (or select from several choices of commentary) (1319) that was already in the database and associated with the particular entry. In another preferred embodiment, age-event information can be accompanied by either sound or video related to that information. Thus, an electronic greeting card that uses age event information relating to a famous speech given by a politician or other leader might include video and/or audio excerpts from that speech; an electronic greeting card that uses age event information relating to the death of an individual in a car accident might include the sound of a crashing car.

In the preferred embodiment of FIG. 13, the user also has the ability to select the design for the greeting card (1321). In a preferred embodiment, each age-event has associated with it one or more designs, which can be a depiction of the event, the individual involved in the age event, or a simulated (or a facsimile of an actual) newspaper article relating to the event in the age-event database. The design can include video, animation, and/or sound. The program can offer possible selections that the creators of the program (or the web-site operators, for an Internet embodiment) believe to be appropriate for the particular age-event, but the user is free to substitute a generic design, or, in some embodiments, the user is free to create her own design. In cases where two or more age-events from the age-event database correspond to a particular exact age, a user has the option of putting more than one design on a card (e.g. having a split design card), or having a multiple page card. In other preferred embodiments, the user can select from various designs that are not necessarily directly related to the age-event (e.g. they could be related to the person parameter or event parameter associated with the age-event).

In a preferred embodiment, after selecting the design, the user has the ability to edit the greeting card (1317), for example to modify the text of the ageliner, to modify preexisting commentary, or to add commentary to personalize the ageliner by relating it to the situation of the target individual.

As an example of the utility of the invention, consider the case of the user who wants to send a friend a card or simply an e-mail greeting, and is looking for an occasion to send it on. Rather than wait until the next official greeting card holiday (such as Office Assistants' Day, Bosses' Day, or Chiropractors' day), the user can input the birthdate of the target, and as output receive information from the age-event database for a period of time in the future. Thus, after inputting her friend's birthdate and (optionally) specifying an interest in seeing information for the next ten days, the user can then select the piece of information that she believes is best suited for her friend, and can arrange, through the computer, to have a greeting containing the information sent to the friend on the date that the friend is exactly as old as the person in the database. Depending on the size of the age-event database, the date-range selected for sending the greeting, and the age of the target individual, the user may have several age-event entries to choose from. Typically, the user will select the entry or entries that the user judges will be of most interest to the target individual (or the entry for which the user believes she can create the best personalized commentary, as described below).

In addition to providing an “excuse” to send a greeting card, the age-event database can be used to obtain information that will make more interesting a greeting card (or other communication) that was going to be sent anyway. Thus, even a person writing a letter by hand, or sending a greeting card on a typical “greeting card day”, such as Father's Day, might find it amusing to learn age-event information relating to the intended recipient (or to the writer), and to include that information (along with appropriate commentary) in the letter.

In a preferred embodiment, the user has the option of typing some personalized text into the greeting, in an attempt to personalize the card even further, for instance, by a snide remark, or by personal commentary. Thus, for instance, if the user's friend is about to turn the exact age that Elvis Presley was when he died, the output might be: “Oct. 10, 1999—you are exactly as old as Elvis Presley was when he died.” To this, the user might add: “Stay away from sleeping pills and pink bathrooms,” or a similar piece of commentary already associated with the age-event entry in the computer system. In embodiments of this invention where the same program is used by more than one user as, for example, an Internet implementation of the invention—after inputting this snide remark, the user is given the option of permitting subsequent users to view and then use the same commentary for that particular item from the age-event database. In order to generate amusing commentary, the web-site can hold contests in which the general public is invited to submit suggested commentary for selected age-event entries.

After the card has been selected, the user has the option of reviewing the card (1323), and can return to the editing and selecting process to make any desired changes. The user can then instruct the computer system to send the card to the target individual (1325). The card could be sent either as an e-mail, as an attachment to an e-mail, or as an e-mail that specifies the web-site location at which the card can be viewed. As is known to those with skill in the art, such an email can either be sent from the user's browser, or can take the form of an email to the target from the web-site, announcing that the target has been sent a greeting by the user. In another preferred embodiment, the greeting card can be sent via a fax machine or other telephone-based mode of communication, or over a smart-television or other cable-based mode of communication. For a stand-alone greeting card creation kiosk embodiment of this invention, the greeting card is typically printed at the site.

In a preferred embodiment, the greeting card is normally sent on the day that the target individual is the same age as the individual from the database. In a preferred embodiment, the greeting card need not be sent or received on the exact age-event date; in such cases, any disparity between the age-event date and the actual date can be addressed in commentary. For example, “last Saturday, you were exactly as old as Leonardo Da Vinci when he finished ‘The Last Supper,’” or “next Saturday you will be exactly as old as Neil Armstrong was when he stepped on the moon.” In addition, sometimes the historical event will have taken place over a range of dates—e.g. someone being held hostage, someone suffering from an illness, making a long trip, slowly dying from gunshot wounds, etc. In such a case, the sender (in commentary) could explain that the target's chronological age puts her in the middle of the famous person's ordeal (and the commentary can point out that on an upcoming day, the famous person would have finished the ordeal or been finished by it).

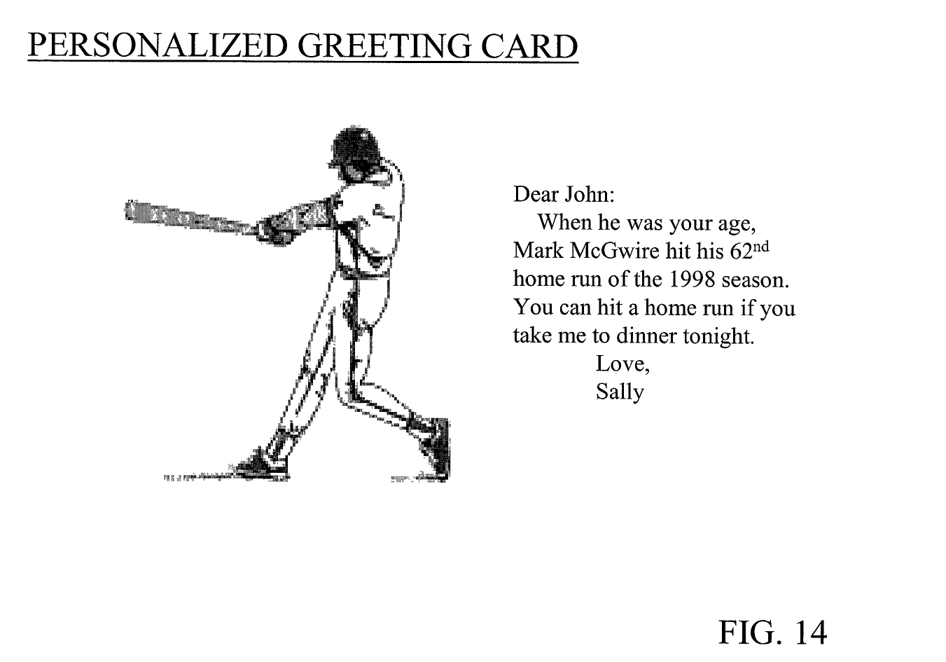

FIG. 14 depicts a greeting card as may be generated by the present invention. Here, the user has found that Mark McGwire hit his 62d home run of the 1998 season when he was the target's age, and has drafted appropriate commentary linking McGwire's feat to an action that the user wishes the target to take.

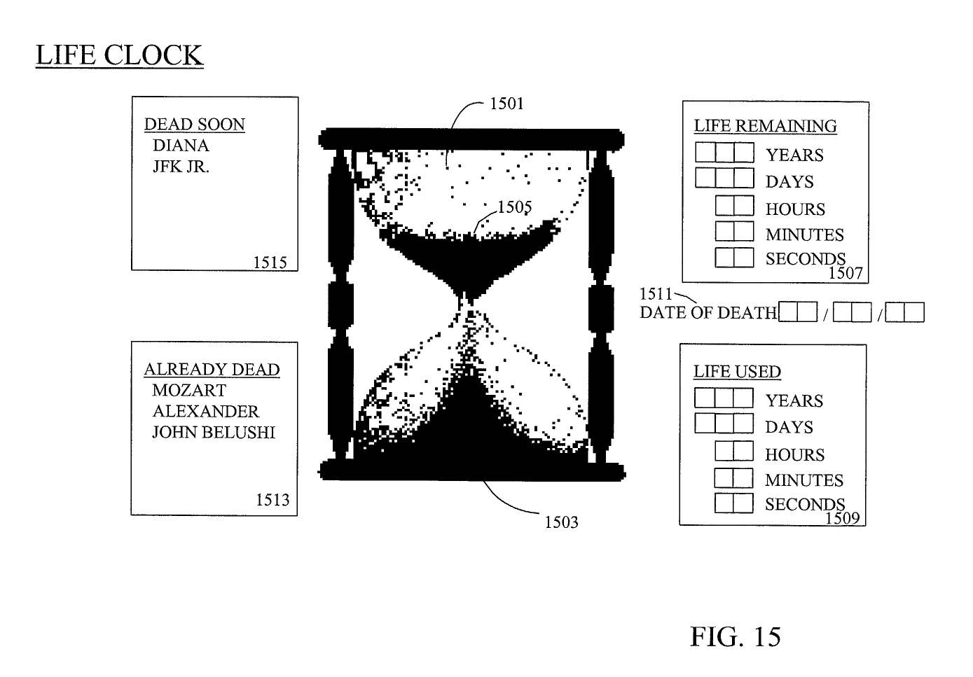

FIG. 15 depicts a life-clock as may be generated by the present invention. In the depiction of FIG. 15, the life-clock is an hour-glass with sands falling from the top chamber 1501 to the bottom chamber 1503, but any other representation of the passage of time can also be a life-clock. Thus, simply providing the numerical data concerning life lived and life to live in a continuously updated form is a life-clock within the scope of the present invention. A spiral, a maze, or a geometric shape with an indicator of progress from one point to another (where the points represent the beginning and end of life), or a shape that can fill up or empty over time, is also a life-clock within the scope of the present invention. A picture of a face where, as time passes, an increasingly large portion of the face becomes a skull is also a life-clock, as is a picture of a face that uses computer-enhanced aging technology to “update” itself as time passes, as is a picture of a face—like that of Dorian Gray—that ages and degenerates over time.

Based on the birthdate of the user, and optionally based on additional information of importance to actuaries or those with skill in the actuarial art (such as family medical history, smoking, marital status, exercise routine, diet, living location, etc.) a life expectancy of the individual user is calculated. Alternatively, for persons who have been told by a doctor that they only have a certain period of time left to live, this period of time can be directly input by the user. Based on this information, a computer-generated clock object is constructed, showing the user how much time he has left—as depicted by the grains of sand yet remaining to fall and an optional running digital “timer” indicating to the second how much time the user has left; as well as the sand at the bottom of the hourglass that represents the life-time already used up, and an optional running digital “timer” advising the user of her exact age (i.e. life lived). The actuarially-calculated life expectancy can optionally be updated periodically—for example on a daily or incremental basis—recognizing that each additional day (or increment) lived increases the actual expected life-span of that individual by some incremental amount.

A user viewing his life-clock is thus presented with information (for example, in days, hours, minutes and/or seconds left, and/or as an absolute date) relating to how much time that individual has left on earth. In addition, the user views a graphic depiction of the sands of his life slipping away, as the sand in the hour glass falls from the upper portion of the hourglass to the lower portion. Optionally, each second that passes is represented by a particular grain of sand, and each minute is represented by something slightly larger, or of more apparent worth. In one embodiment, hours, days, weeks, months and years might be separately marked, to more clearly stress to the user the magnitude of the chunk of time that has just passed. The invention thus reminds the user of the irretrievability of spent time, and encourages the user to make the most left of the time left to her.

A life-clock of this nature can be usefully tied into the people-event database described above. Thus, the life-clock can provide information about a famous person and what that famous person did at the age depicted on the life-clock. As depicted in FIG. 15, the life-clock can provide a list of individuals who died around the same age as the user—those who have already died at the user's age and/or those who died at a slightly older age. Alternatively, a list of accomplishments of famous people of about the same age as the user could be provided. Similarly, the life-clock can provide a depiction of the death of a famous person at the user's age. Thus, in a preferred embodiment, when the user is exactly as old as a particular famous person was when he or she died, an image of a person (or a head or a skull) appears in the hourglass, stuck in the chute between future and past for one discrete period of time (e.g. 24 hours). At the end of the period of time, the image falls into the past, and becomes buried in the sands of time.

Optionally, the user viewing his life-clock would have access to information about all those individuals in the age-event database who died at a younger age than he, and all those who died at an age he has not yet attained. In one preferred embodiment, the sands of time may optionally be replaced by tiny figures, each one representing someone who died, or is yet to die. Clicking on such a figure (or in an alternative embodiment without the figures, a grain of sand) would provide the user with information from the age-event database about that individual.

The life-clock depicted in the preferred embodiment of FIG. 15 comprises an upper chamber 1501 and a lower chamber 1503. Sand 1505 flows from the upper chamber to the lower chamber as time passes; thus, the sand remaining in the upper chamber is a representation of life still to live, and the increasing pile of sand in the bottom chamber represents life (or time) that has been used up. Counter 1507 provides a numerical reading, in this case, to the second, of how much life is remaining, and counter 1509 provides a numerical reading of how much life has been used up. In a preferred embodiment, the sum of the numbers presented by counters 1507 and 1509 is the actuarily calculated life expectancy of the individual for whom the life-clock has been produced. In a preferred embodiment, the actuarily-calculated life expectancy increases incrementally with each additional increment of time lived, and this calculation is performed and taken into account in the calculation of the number representing life yet to live. In a preferred embodiment, this calculation is performed automatically, such that each successive reading of the counter 1507 takes into account the incremental increase in life expectancy. In such an embodiment, there is not a one-to-one correspondence in changes in time lived (counter 1509) and time yet to live (counter 1507). In other embodiments, the actuarial update occurs periodically, such as on a daily basis, such that the one-to-one correspondence of changes in the counters 1507 and 1509 occurs except for at the discontinuous moment of the update, which adds an increment of time to counter 1507.

In the embodiment depicted in FIG. 15, the projected date of death is also provided (1511).

In the embodiment depicted in FIG. 15, age-event information from an age-event database is also provided in displays 1513 and 1515. In the depicted embodiment, the only information provided is that certain age-event individuals were already dead at the user's age, and that others died when they were slightly older than the user. In other preferred embodiments, additional age-event information including accomplishments, dates, ages, and commentary is available, and can be displayed automatically on the screen, or displayed selectively in accordance with user preferences, and/or can be accessed by the user from the life-clock display.

Thus, the life-clock can draw from the age-event database to provide useful and entertaining information to the user. Similar to the greeting card and calendar applications of the age-event database, the user can filter age-event information according to the user or target's personal preferences. Because events in the age-event database will typically only be reported to an accuracy of one day (i.e. a 24-hour period), an age-event corresponding to the current age of the individual for whom the life-clock has been produced will be reported for a 24-hour period, corresponding to the day on which the target individual is the same age (to the day) as the individual from the age-event database involved in the age-event. Although for general purposes, it is preferable (but not essential) in the case of the life-clock to input the user's birthdate as accurately as possible (for example, to the minute, as reflected in hospital records), for purposes of the life-clock in conjunction with the age-event database, the assumption is preferably made that an individual (including the target and the age-event individual) was born on a particular 24-hour calendar day, and that his age in days changes on subsequent midnights, rather than at the exact time of day on which the individual was born.

In a preferred embodiment, key age-events from the database (which can be preselected by the person who creates the life-clock) are represented by icons or other graphical images in the chambers, where, for example in the top chamber, the age-event's closeness in time corresponds to how close it is to the grains of sand currently flowing from the top chamber to the bottom chamber. In a preferred embodiment, the age-events only materialize when they are within a certain temporal proximity to the current date. Thus, for example, a skull representing the death of an age-event individual might only materialize in the upper chamber when the target individual is within 10 days of the age at death of the age-event individual. Under such circumstances, clicking on the skull will provide the age-event information related to the death of the age-event individual.

In another preferred embodiment, clicking on a grain of sand at a location in the top chamber (1501) provides age-event information for an age corresponding to that grain of sand, as does clicking on a grain of sand at a location in the bottom chamber. Because screen resolution currently does not does not permit the many thousands of dates in a person's life-time to each be represented by a single grain of sand, in a current preferred embodiment clicking on a grain of sand provides access to age event information for a particular block of time represented by that grain of sand, and more precise age-event information can be obtained by further clicking.

In another preferred embodiment designed to maximize the use of the computer screen, the life-clock comprises a large portion (if not all) of the display screen, where time left to live is represented by pixels that are “lit,” whereas time lived is represented by pixels that are dark. The unit of time corresponding to each lit pixel can be precisely calculated by dividing the time left to live by the number of pixels. In another preferred embodiment, the life-clock comprises a plurality of tiny candles—preferably as many as can fit on the screen—and passage of time is marked by the candles going out, or being blown out, periodically. In such an embodiment, a countdown to the time that the next candle will be blown out can be provided.

In a preferred embodiment of a life-clock involving sequential changes to the depiction of the life-clock, the changes are also marked by sounds from the computer system. Thus, a candle going out might be accompanied by the sound of someone blowing out a candle; similarly, a pixel going out might be accompanied by a simple beeping sound. Age-event information on the life-clock can also be accompanied by sounds relating to that information (thus, the age event information that someone died at particular age could be accompanied by the sound of someone dying). Such multimedia enhancements may be provided automatically, or may be activated by input from the user.

In another preferred embodiment of the life-clock, countdown timers to significant events are provided. Thus, a user wishing to match or beat the accomplishment of a particular age-event individual can create a countdown timer that lets him know how much time he has left until he is the age at which the age-event individual accomplished the feat. Thus, a writer working on his first novel might create a countdown timer that would indicate how long he before he is the age at which his favorite writer wrote her first novel.

The life-clock age event product is also susceptible of being made into a greeting card. Thus, by inputting a target individual's birthdate, and answering (to the extent the answers are known), certain well-known questions used by actuaries in calculating life expectancy, a greeting card sender can generate a life-clock for a target, for a particular date. The life-clock greeting card could provide age-event information for (for example) the 20-day period surrounding the date on which the card is to be sent—10 days into the future, as well as 10 days into the past. As with other greeting cards of this invention, in a preferred embodiment, the creator would have the opportunity to add text to personalize the card, for example by relating the age-events to the life of the target individual. Such a life-clock could be sent as an electronic greeting card (as discussed above), as an attachment to or the body of an e-mail, or as a hard copy greeting card.

Yet another use of the age-event database is for producing a life chart. The life chart can be an electronic product, or can be bound as a book, and contains information, by date, of what other individuals accomplished when they were the age of the target individual on a given date. In a preferred embodiment, the life chart consists of a series of calendar entries that cover most or all of the life-span—past, present, and future—of the individual. Alternatively, some subset of the life of the individual could also be chosen. Where the target individual's past accomplishments are known, and can be associated with dates, this information can also appear on the life chart for the past. Like the other embodiments, the life chart can be created with or without using filters. As in the case of calendars, one option is to not filter the output initially, but then, upon viewing the output, simply to delete those entries that are not desired.

An Internet embodiment of the invention can also be useful for a web-site that provides biographical or historical information.

In a simple embodiment, the computer system of this invention provides age-event information as output in response to input consisting of age information. In a preferred embodiment, the user can then do with this information whatever she wishes to do. Thus, a user may access the computer system to obtain age-event information on a friend, and then incorporate that age-event information in an e-mail or other communication with that friend. Similarly, someone planning a party could obtain age-event information for each invited guest, and include that information on the invitations.

The age-event database need not be used only for applications where the age of a target individual is known to the day, and the information from the age-event database involves individuals who were the same age, to the day. For example, the age-event database can also be used to generate a birthday card that provides a list of accomplishments of others at the age (in complete years) that the target individual has just turned. Such a card need not be sent on a birthday; a 25-year-old person may always be curious to know what other individuals accomplished when they were 25 years old.

Another use for the computer system of this invention is to provide input for a display for a television that is controlled by a computer. While televisions currently can receive input from computers, it is anticipated that in the near future, televisions will have computers built into them such that content can be programmed by the user in addition to the television program being watched. The present invention includes the display of age-event information by a television controlled by a computer, as for example, a television-computer hybrid. Thus, a family might input birthdates of the family members into the computer, and then on each day, age event information for each family member would be displayed on the viewing screen of the device (as, for example, horizontally scrolling text (like a weather warning) that does not interfere with the viewing of the regular programming.

The age-event database can be used for numerous purposes related to comparing a user's age to the age of other individuals at the time of a certain event. Common to all embodiments is the possibility that the people-event database contain additional information—or links to additional information—concerning either the person or the event from the people-event entry that is being presented to the user. Thus, for an embodiment where the age-event entry for JFK becoming president is called up, the user would be informed of that fact, and would also be presented additional information about Kennedy or the institution of the United States presidency, or with links to more biographical information about John F. Kennedy, and/or information about the institution of the presidency. As a revenue-generating means for an Internet embodiment of the invention, items related to JFK (such as books) could be sold on the web-site or through links to other web-sites.

In another preferred embodiment, the invention could also be used to provide age-event information to an individual that includes only age-events that occurred in the lives of individuals as old as or younger than the target individual, or younger or older than the target individual by a specified amount. For example, a 30-year old baseball player might be interested in a list of accomplishments of baseball players his age or younger, and might also be interested in a list of accomplishments of baseball players 31 years or younger, in order to have a more complete list of relevant age-events for use in the upcoming season. In this embodiment—an embodiment that is particularly useful in sports and other areas where statistics are kept, and where statistics accrue incrementally—the age event database typically contains more detailed information concerning the age-event individuals. Thus, every event that causes a change in a player's lifetime statistics—e.g. each hit, each home-run, each stolen base, each pitching victory—is included in the age-event database. A player might then select a small number of age-event individuals to use for comparison purposes, and could thus conduct a daily comparison between his statistics and those of the age-event individuals at his age.

In a preferred embodiment, the age-event database can also be used in reverse. Thus, the events in the age-event database are fully searchable, using any search engine known in the art. Preferably, the user is given the opportunity to search the database to find age-events that correspond to an event that has occurred, or is about to occur, in the life of a target individual. Thus, if the target individual is about to have a book published, or has won election to public office, or is getting married, the age-event database can be readily queried to provide information about the ages at which individuals in the age-event database published their first book, won an election, or got married. For example, if the user has a first child, the database can tell that user which famous individuals had a child at approximately that age, or sometime before, or sometime later. Similarly, the user could query the age-event database to find out when age-event individuals achieved a particular military rank. Information of this sort from the age-event database can also be provided on greeting cards, to be sent to people to mark a specific event in their lives. For example, when a friend has his or her first child, the greeting card might provide information as to the age at which individuals from the age-event database of interest to the friend had their first child.

In addition to the various potential products based on the age-event database, the age-event database could be available for simple queries, which could provide age-event information that the user could use as he sees fit. Thus, a user might visit a web-site on a daily basis just to see what age-events turn up for his exact age. Similarly, a user might obtain age-event information on himself and/or a target individual simply for use in conversation or correspondence.

It will be apparent to those skilled in the art that the invention described herein is not limited to the specific preferred embodiments discussed above and that various modifications can be made to the herein-described method and apparatus for customizing date information without departing from the scope or spirit of the invention. It is also intended that the present invention cover modifications and variations of the method and apparatus for customizing date information within the scope of the appended claims and their equivalents.

I claim:

1. A computer-implemented method for providing a user with age-event information comprising:
a) receiving an input signal comprising age information; and
b) providing an output signal comprising age-event information corresponding to said age information.

2. The method of claim 1, wherein the input signal comprises a date, and the output signal comprises a celebrity ageliner.

3. The method of claim 1, wherein the input signal comprises age information relating to a target individual, and the output signal comprises age-event information customized for said target individual.

4. The method of claim 3, wherein the output signal further comprises a date; and the age event information customized for said target individual comprises information about an event in the life of an age-event individual when the age-event individual was the same age as the target individual on said date.

5. The method of claim 1, wherein the input signal comprises a birthdate.

6. The method of claim 1, wherein the input signal comprises an age in years.

7. The method of claim 1, wherein the output signal is obtained by comparing the input signal to an age-event database, and selecting at least one item from the age-event database that corresponds to an age that derives from said inputted age information.

8. The method of claim 4, further comprising the step of generating a customized greeting for the target individual.

9. The method of claim 8, where the customized greeting is an electronic greeting card.

10. The method of claim 8, where the customized greeting is a greeting card produced at a an automated greeting card kiosk.

11. The method of claim 3, further comprising the step of generating a customized calendar for the target individual.

12. The method of claim 3, further comprising the step of generating a life-chart for the target individual, wherein said life-chart comprises age-events related to at least about one year of the life of said target individual.

13. The method of claim 3, further comprising the steps of generating a life-clock display for the target individual, wherein said life-clock display comprises a symbolic representation of the amount of life an individual has lived and the amount of life an individual has remaining; and providing age-event information on said life-clock display.

14. A computer system for providing age-event information, comprising:
computer processor means for processing data;
storage means for storing data on a storage medium;
means for receiving age information input; and
means, responsive to said receiving means, for outputting age-event information to a user.

15. The computer system of claim 14, further comprising means for generating a celebrity ageliner.

16. The computer system of claim 14, further comprising means for generating a customized greeting from the user to a target.

17. The computer system of claim 14, further comprising means for generating a customized calendar.

18. A computer memory storage device encoded with a computer program for using a computer system to provide age-event information comprising:
means for inputting age information; and
means for providing age-event information as output.

19. The computer memory storage device of claim 18, further comprising means for generating a customized greeting.

20. The computer memory storage device of claim 18, further comprising means for generating a customized calendar.
